(19) United States
(12) Patent Application Publication
(10) Pub. No.: US 2012/0086342 A1
(43) Pub. Date: Apr. 12, 2012

(54) Discharge Tube Lighting Device And Abnormal Discharge Detecting Method In The Same

(75) Inventor: Tadashi Iwabuchi, Osaka (JP)

(73) Assignee: SHARP KABUSHIKI KAISHA, Osaka-shi, Osaka (JP)

(21) Appl. No.: 13/377,066

(22) PCT Filed: Feb. 10, 2010
(86) PCT No.: PCT/JP2010/051944

§ 371 Date: Dec. 8, 2011

(30) Foreign Application Priority Data
Jul. 21, 2009 (JP) 2009-169847

(51) Int. Cl. H05B 37/03

(52) U.S. Cl. 315/130; 315/129

(57) ABSTRACT

A high-voltage transformer drive circuit and a high-voltage transformer drive discharge tubes. In at least one example embodiment, a tube current synthesis/high pass filter circuit synthesizes tube currents in the discharge tubes, and extracts a pulse component resulting from arc discharge from the synthesis tube current. A pulse hold circuit holds the extracted pulse component for a predetermined time. A comparator compares an output from the pulse hold circuit with a threshold value, and outputs a signal indicating the presence or absence of the arc discharge. Upon detection of the arc discharge, a logic circuit stops the operation of the high-voltage transformer drive circuit. Thus, arc discharge is detected with high accuracy at low cost.

### TECHNICAL FIELD

The present invention relates to a discharge tube lighting device for lighting a discharge tube, and an abnormal discharge detecting method for detecting arc discharge occurring at the discharge tube lighting device.

### BACKGROUND ART

Various liquid crystal display devices such as a liquid crystal television set are each provided with a backlight including a cold cathode discharge tube. A discharge tube lighting device including an inverter circuit is used for lighting the cold cathode discharge tube. The cold cathode discharge tube needs to be lit at a high voltage. Therefore, the discharge tube lighting device includes a high-voltage transformer, and the cold cathode discharge tube is connected to a secondary side of the high-voltage transformer.

In the discharge tube lighting device that generates a high voltage as described above, arc discharge may occur at a contact failure portion or a withstand voltage failure portion. For example, in a case where contact failure occurs at a connector section for connecting between the secondary-side terminal of the high-voltage transformer and the discharge tube, and other cases, arc discharge occurs at the contact failure portion. When arc discharge occurs, a resin-made member (for example, a connector housing) or the like in the vicinity of a place where the arc discharge occurs is fumed, ignited or carbonized because of discharge sparking, so that there arise possibilities of a burn of equipment, a fire, and the like.

A typical discharge tube lighting device includes a protection circuit that senses a fact that a current to be flown into a discharge tube becomes too small or a fact that an over-voltage is generated at a secondary side of a high-voltage transformer, and stops the operation of the device. However, even when arc discharge occurs, in many cases, a lighting current flows through the discharge tube although the amount thereof is not normal, and a voltage to be applied to the discharge tube does not rise to a degree that such a voltage rise is determined as an abnormal condition. Moreover, in a typical backlight system, currents to be flown into discharge tubes are controlled to be almost constant in order to achieve uniform brightness in the discharge tubes. For this reason, when arc discharge occurs, a protection circuit for detecting an under-current or an over-voltage never stops the operation of a discharge tube lighting device. Accordingly, the discharge tube lighting device needs to include a separate protection circuit for detecting arc discharge to stop the operation of the device.

In principle, arc discharge is detected by sensing an electromagnetic wave, a discharge light, ozone, a discharge sound or the like to be generated in association with the arc discharge. Arc discharge detecting methods in a discharge tube lighting device are described in, for example, Patent Documents 1 to 5. Patent Document 1 describes a configuration that a discharge detecting pattern is provided on a printed board in order to sense a voltage to be induced in the discharge detecting pattern because of an electromagnetic wave associated with arc discharge. Patent Document 2 describes a configuration that a similar inducing pattern section is provided on a bottom surface of a transformer and in the vicinity of a lamp in a printed board. Patent Document 3 describes a configuration that a high pass filter is used for sensing a discharge noise frequency component mixed in a tube current flowing through a discharge tube. Patent Document 4 describes a configuration that a capacitor is used for sensing a frequency component of a discharge pulse to be generated at a secondary side of a high-voltage transformer. Patent Document 5 describes a configuration that output control means is provided for increasing an output current from an inverter circuit, and arc discharge is detected based on an input current to the inverter circuit while the output control means operates.

Moreover, a method shown in FIG. 10 is practically used as an arc discharge detecting method in a discharge tube lighting device (hereinafter, such a method will be referred to as a tube current difference detecting method). In a discharge tube lighting device shown in FIG. 10, discharge tubes 1 are provided in twos, and currents which are opposite in phase are flown into the pair of discharge tubes 1. A tube current difference detection circuit 91 performs addition of the tube currents flowing through the pair of discharge tubes 1. The sum of tube currents becomes almost zero in a case where arc discharge does not occur (hereinafter, such a case will be referred to as a normal condition), and is shifted from zero when arc discharge occurs. A comparator 93 outputs a signal indicating occurrence of arc discharge to a control circuit 11 when a synthesis tube current inputted thereto via a low pass filter 92 exceeds a predetermined threshold value. In addition, a method for detecting a difference between tube voltages at two discharge tubes, a method for detecting a change of a tube current in one discharge tube, and the like are exemplified as an arc discharge detecting method in a discharge tube lighting device.

### PRIOR ART DOCUMENTS

### Patent Documents

[Patent Document 1] Japanese Laid-Open Patent Publication No. 2007-134290
[Patent Document 2] Japanese Laid-Open Patent Publication No. 2002-341775
[Patent Document 3] Japanese Laid-Open Patent Publication No. 2002-151287
[Patent Document 4] Japanese Patent Gazette No. 3123161
[Patent Document 5] Japanese Laid-Open Patent Publication No. 2008-186614

### SUMMARY OF THE INVENTION

### Problems to be Solved by the Invention

However, the arc discharge detecting methods described in Patent Documents 1 to 5 have the following problems. In the methods described in Patent Documents 1 and 2, various kinds of noise are mixed into a voltage at the discharge detecting pattern and a voltage at the inducing pattern section, in addition to noise due to an electromagnetic wave associated with arc discharge. For this reason, it is impossible to obtain an S/N ratio for allowing correct detection of arc discharge. As the result, it is possible to detect arc discharge theoretically, but it is impossible to detect arc discharge correctly in an actual device.

The methods described in Patent Documents 3 and 4 are intended to detect an instantaneously generated factor such as a discharge pulse or discharge noise associated with arc discharge. For this reason, it is impossible to detect arc discharge correctly in a case where the arc discharge occurs intermittently, for example, in a case of performing so-called burst dimming (to change the brightness of a discharge tube by forming a voltage for driving the discharge tube in a burst manner and changing the burst time width). Moreover, there arises a problem that even in a case of occurrence of small arc discharge which does not lead to fuming or igniting because of contact failure in a considerably short time, a protection circuit operates more than necessary to stop the operation of the discharge tube lighting device. In the method described in Patent Document 5, although the cost increases because of the complicated scheme, arc discharge detecting accuracy does not reach desirable accuracy for the cost in some cases.

Moreover, the tube current difference detecting method has the following problems. The discharge tube lighting device for lighting not less than two discharge tubes performs current balancing control to balance amounts of tube currents flowing through the discharge tubes in order to achieve uniform brightness in the discharge tubes. For this reason, even when a radio-frequency pulse component is superimposed on a tube current upon occurrence of arc discharge, an effective value and an average value do not vary so much with regard to a tube current. Consequently, there is no remarkable difference between a synthesis tube current (a difference between tube currents) upon occurrence of arc discharge and a synthesis tube current (a difference between tube, currents) in a normal condition. Accordingly, in order to detect a change of a synthesis tube current (a difference between tube currents), a threshold value (corresponding to Vref) of the comparator 93 needs to be made small as much as possible to such a level that erroneous operation is caused by circuit noise.

However, tube currents fluctuate or change because of a characteristic variation in a discharge tube, a characteristic change due to temperature, a transition of usage, and the like. Consequently, the difference between the tube currents increases even in such a situation that the current balancing control is performed in a normal condition. For this reason, when the threshold value of the comparator 93 is made small, arc discharge is detected erroneously even in a normal condition in some cases. Accordingly, the tube current difference detecting method requires enormous times and efforts to set a threshold value of the comparator 93 so as to detect arc discharge correctly upon occurrence of arc discharge and to prevent erroneous detection of arc discharge in a normal condition. Other conventional arc discharge detecting methods also have similar problems.

Hence, it is an object of the present invention to provide a discharge tube lighting device capable of detecting arc discharge with high accuracy at low cost.

### Means for Solving the Problems

According to a first aspect of the present invention, there is provided a discharge tube lighting device having an abnormal discharge detecting function, the discharge tube lighting device including: a drive circuit that drives a discharge tube; a high pass filter that takes one of a tube current in and a tube voltage at the discharge tube as a processing target signal, and extracts a pulse component resulting from arc discharge from the processing target signal; a pulse hold circuit that holds the pulse component for a predetermined time; and a comparator that compares an output from the pulse hold circuit with a threshold value, and outputs a signal indicating the presence or absence of the arc discharge.

According to a second aspect of the present invention, in the first aspect of the present invention, the discharge tube lighting device further includes a synthesis circuit that synthesizes the processing target signals with regard to a plurality of discharge tubes, and outputs a signal obtained by the synthesis to the high pass filter, wherein the drive circuit classifies the plurality of discharge tubes into two groups, and applies voltages, which are opposite in phase, to the discharge tubes in the respective groups.

According to a third aspect of the present invention, in the first aspect of the present invention, the discharge tube lighting device further includes a timer circuit that sets a time elapsed since a signal has changed to an abnormal level until occurrence of an abnormal condition is determined, wherein in the timer circuit, a timer time for detecting arc discharge is shorter than a timer time for detecting a different abnormal condition.

According to a fourth aspect of the present invention, in the first aspect of the present invention, the pulse hold circuit has a characteristic that when an input exceeds a predetermined level, an output changes from an initial state, and then the changed output gradually returns to the initial state.

According to a fifth aspect of the present invention, in the fourth aspect of the present invention, an attack time of the pulse hold circuit is set such that an output changes in response to the pulse component.

According to a sixth aspect of the present invention, in the fourth aspect of the present invention, a hold time of the pulse hold circuit is set such that the comparator detects the arc discharge when the pulse component is inputted at not more than predetermined time intervals.

According to a seventh aspect of the present invention, in the second aspect of the present invention, the pulse hold circuit has a characteristic that when an input exceeds a predetermined level, an output changes from an initial state, and then the changed output gradually returns to the initial state, and includes a bipolar transistor that changes the output when the input is changed.

According to an eighth aspect of the present invention, in the first aspect of the present invention, a time constant of the high pass filter is set such that a discharge tube driving frequency component of the processing target signal is attenuated sufficiently as compared with the pulse component.

According to a ninth aspect of the present invention, in the first aspect of the present invention, the pulse hold circuit includes a one-shot multi-vibrator that outputs a pulse having a predetermined width when an input exceeds a predetermined level.

According to a tenth aspect of the present invention, in the first aspect of the present invention, the pulse hold circuit operates only when one of the tube current and the tube voltage, which is not taken as the processing target signal, exceeds a predetermined level.

According to an eleventh aspect of the present invention, there is provided an abnormal discharge detecting method in a discharge tube lighting device, including: a step of taking one of a tube current in and a tube voltage at a discharge tube as a processing target signal, and performing high pass filter processing to extract a pulse component resulting from arc discharge from the processing target signal; a step of holding the pulse component for a predetermined time by using a pulse hold circuit; and a step of comparing an output from the pulse hold circuit with a threshold value, and determining the presence or absence of the arc discharge.

According to a twelfth aspect of the present invention, in the eleventh aspect of the present invention, the abnormal discharge detecting method further includes: a step of classifying a plurality of discharge tubes into two groups, and applying voltages, which are opposite in phase, to the discharge tubes in the respective groups; and a step of synthesizing the processing target signals with regard to the plurality of discharge tubes, and obtaining a signal to be subjected to the high pass filter processing.

According to a thirteenth aspect of the present invention, in the eleventh aspect of the present invention, the abnormal discharge detecting method further includes a step of setting a time elapsed since a signal has changed to an abnormal level until occurrence of an abnormal condition is determined, by using a timer circuit, wherein in the timer circuit, a timer time for detecting arc discharge is shorter than a timer time for detecting a different abnormal condition.

According to a fourteenth aspect of the present invention, in the eleventh aspect of the present invention, the pulse hold circuit has a characteristic that when an input exceeds a predetermined level, an output changes from an initial state, and then the changed output gradually returns to the initial state.

According to a fifteenth aspect of the present invention, in the eleventh aspect of the present invention, the pulse hold circuit includes a one-shot multi-vibrator that outputs a pulse having a predetermined width when an input exceeds a predetermined level.

### Effects of the Invention

According to the first, second or eleventh aspect of the present invention, it is possible to detect arc discharge with high accuracy by extracting a pulse component resulting from arc discharge from a tube current in or a tube voltage at the discharge tube by using the high pass filter, holding the extracted pulse component for a predetermined time by using the pulse hold circuit, and comparing an output from the pulse hold circuit with a threshold value. In particular, by holding the extracted pulse component for the predetermined time, it is possible to detect, with high accuracy, small arc discharge which occurs in a case of a narrow discharge gap, has a small average pulse amplitude, and has the small number of pulses having enough amplitude to be taken in by the pulse hold circuit, and arc discharge which occurs intermittently in a case of performing burst dimming, and other cases. Moreover, by extracting only a pulse component resulting from arc discharge by using the high pass filter, it is possible to detect arc discharge widely from small arc discharge to large arc discharge without being affected by a fluctuation or variation in a discharge tube driving frequency component of a tube current in or a tube voltage at the discharge tube.

According to the second or twelfth aspect of the present invention, by synthesizing tube currents in or tube voltages at the plurality of discharge tubes to which voltages, which are opposite in phase, are applied in the respective groups, it is possible to reduce a discharge tube driving frequency component of a synthesis signal to a sufficiently small level as compared with a pulse component. Accordingly, it is possible to reduce the cost of the discharge tube lighting device in such a manner that an inexpensive high pass filter having a simple configuration is used for extracting a pulse component resulting from arc discharge.

According to the third or thirteenth aspect of the present invention, by setting a timer time for detecting arc discharge to be shorter than a timer time for detecting a different abnormal condition (for example, abnormal current or abnormal voltage), it is possible to detect arc discharge, which may cause a damage of equipment, a fire, and the like, more quickly, to stop the lighting of the discharge tube, and to enhance the safety of the device.

According to the fourth or fourteenth aspect of the present invention, by using the circuit having the characteristic described above, it is possible to constitute the pulse hold circuit that holds a pulse component extracted by the high pass filter for a predetermined time, at low cost.

According to the fifth aspect of the present invention, by setting an attack time of the pulse hold circuit as described above, it is possible to reliably change an output from the pulse hold circuit upon occurrence of arc discharge, and to detect the arc discharge with high accuracy.

According to the sixth aspect of the present invention, by setting a hold time of the pulse hold circuit as described above, it is possible to correctly detect arc discharge including small arc discharge which occurs in a case of a narrow discharge gap, has a small average pulse amplitude, and has the small number of pulses having enough amplitude to be taken in by the pulse hold circuit, and arc discharge which occurs intermittently in a case of performing burst dimming, and other cases.

According to the seventh aspect of the present invention, it is possible to improve a reduction characteristic in a case of reducing a discharge tube driving frequency component of a synthesis signal to a sufficiently small level as compared with a pulse component in such a manner that the pulse hold circuit including the bipolar transistor that changes an output when an input is changed is provided at a posterior stage of the synthesis circuit and the high pass filter.

According to the eighth aspect of the present invention, by setting a time constant of the high pass filter as described above, it is possible to correctly extract a pulse component resulting from arc discharge by using the high pass filter, and to detect the arc discharge with high accuracy.

According to the ninth or fifteenth aspect of the present invention, by using the one-shot multi-vibrator described above, it is possible to constitute the pulse hold circuit that holds a pulse component extracted by the high pass filter for a predetermined time, at low cost. Moreover, it is possible to detect, with high accuracy, arc discharge including small arc discharge which occurs in a case of a narrow discharge gap, has a small average pulse amplitude, and has the small number of pulses having enough amplitude to be taken in by the pulse hold circuit, and arc discharge which occurs intermittently in a case of performing burst dimming, and other cases, and to achieve the stable operation of the discharge tube lighting device.

According to the tenth aspect of the present invention, by extracting a pulse component resulting from arc discharge from one of a tube current and a tube voltage, and holding the extracted pulse component only when the other signal exceeds a predetermined level, it is possible to reduce a risk of erroneously detecting a pulse generated in a condition other than arc discharge as a pulse component resulting from arc discharge, and to further enhance arc discharge detecting accuracy.

### BRIEF DESCRIPTION OF THE DRAWINGS

FIG. 1 is a diagram showing a configuration of a discharge tube lighting device according to first and second embodiments of the present invention.

FIG. 2 is a circuit diagram of a pulse hold circuit in the discharge tube lighting device according to the first embodiment of the present invention.

FIG. 3 is a circuit diagram of a timer time switch circuit in the discharge tube lighting device shown in FIG. 1.

FIG. 4 is a block diagram showing a configuration of an arc discharge detecting section in the discharge tube lighting device according to the first embodiment of the present invention.

FIG. 5 is a diagram showing changes in a tube current, a synthesis tube current, and an output from the pulse hold circuit of the discharge tube lighting device shown in FIG. 1, in a normal condition and upon occurrence of arc discharge.

FIG. 6 is a diagram showing an example of arc discharge detection range by the discharge tube lighting device shown in FIG. 1.

FIG. 7 is a circuit diagram of a pulse hold circuit in the discharge tube lighting device according to the second embodiment of the present invention.

FIG. 8 is a block diagram showing a configuration of an arc discharge detecting section in the discharge tube lighting device according to the second embodiment of the present invention.

FIG. 9 is a diagram showing a part of the discharge tube lighting device according to a modification example of the embodiment of the present invention.

FIG. 10 is a diagram showing a configuration of a conventional discharge tube lighting device.

### MODES FOR CARRYING OUT THE INVENTION

### First Embodiment

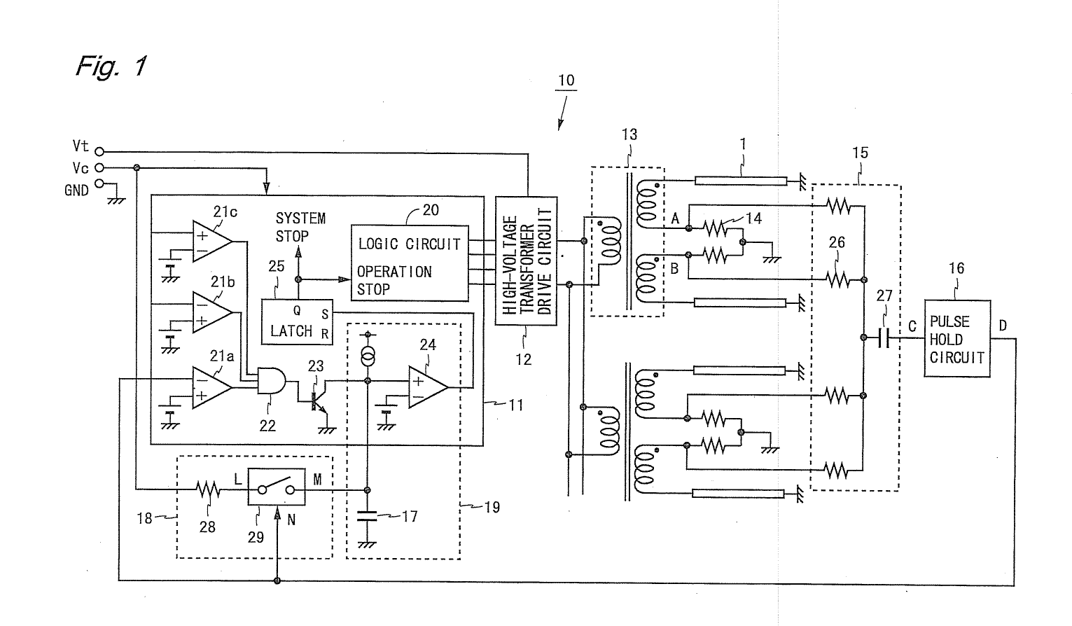

FIG. 1 is a diagram showing a configuration of a discharge tube lighting device according to a first embodiment of the present invention. As shown in FIG. 1, a discharge tube lighting device 10 includes a control circuit 11, a high-voltage transformer drive circuit 12, high-voltage transformers 13, tube current detection resistors 14, a tube current synthesis/high pass filter circuit (hereinafter, referred to as a tube current synthesis/HPF circuit) 15, a pulse hold circuit 16, a capacitor 17, and a timer time switch circuit 18. The discharge tube lighting device 10 has a function of lighting a plurality of discharge tubes 1 and an abnormal discharge detecting function of detecting arc discharge, and stops to light the discharge tube 1 upon detection of arc discharge. It is to be noted that FIG. 1 shows four discharge tubes 1 and two high-voltage transformers 13; however, the number of discharge tubes and the number of high-voltage transformers may be arbitrary.

The high-voltage transformer 13 is a two-in-one transformer (a one-input and two-output transformer having one primary-side winding and two secondary-side windings) that generates a high voltage required for lighting the discharge tube 1. The high-voltage transformer drive circuit 12 is connected to a primary side of the high-voltage transformer 13, and the plurality of discharge tubes 1 are connected to a secondary side of the high-voltage transformer 13. A high-voltage transformer-intended power supply voltage Vt is supplied to the high-voltage transformer drive circuit 12. The high-voltage transformer drive circuit 12 drives the high-voltage transformer 13 in accordance with control by a logic circuit 20 included in the control circuit 11. As described above, the high-voltage transformer drive circuit 12 and the high-voltage transformer 13 function as a drive circuit for driving the discharge tube 1.

The discharge tubes 1 are classified into two groups, and the drive circuit applies voltages, which are opposite in phase, to the discharge tubes in the respective groups. In the discharge tube lighting device 10, the discharge tubes 1 are provided in twos. Voltages which are opposite in phase are applied to the pair of discharge tubes 1, and currents which are opposite in phase flow through the pair of discharge tubes 1. More specifically, two windings which are identical in winding direction to each other (hereinafter, referred to as first and second windings) are provided on the secondary side of the high-voltage transformer 13. One of the pair of discharge tubes 1 is provided between one of terminals of the first winding and a ground. The other discharge tube 1 is provided between an opposite-side terminal of the second winding and the ground. In the first and second windings, terminals which are not connected to the discharge tubes 1 are grounded via the tube current detection resistors 14.

It is to be noted that the discharge tubes 1 may be connected in a form other than that described above as long as the discharge tubes 1 are classified into two groups and are applied with voltages which are opposite in phase. For example, in a case where the discharge tubes 1 the number of which is a multiple of 4 are connected to the high-voltage transformer 13 (two-in-one transformer), voltages which are in phase may be applied to the pair of discharge tubes 1 and currents which are in phase may be flown into the pair of discharge tubes 1. In this case, the high-voltage transformers 13 are classified into two groups. In the respective groups, the high-voltage transformers 13 generate voltages which are opposite in phase. Also in the case of using this connection form, the discharge tubes 1 may be classified into two groups and voltages which are opposite in phase may be applied to the discharge tubes 1 as in the case of using the connection form shown in FIG. 1.

A connection point (for example, a point A or a point B) between the secondary-side winding of the high-voltage transformer 13 and the tube current detection resistor 14 is connected to an input terminal of the tube current synthesis/HPF circuit 15. The tube current synthesis/HPF circuit 15 includes resistors 26 which are equal in number to the discharge tubes 1, and one capacitor 27. In order to detect a tube current correctly as much as possible, the resistor 26 to be used herein has a resistance value which is sufficiently larger than that of the tube current detection resistor 14 (that is, satisfies a relation of R1<<R2 in which R1 represents the resistance value of the tube current detection resistor 14, and R2 represents the resistance value of the resistor 26). A slight part of the tube current which flows through the discharge tube 1 flows to the input terminal of the tube current synthesis/HPF circuit 15 (hereinafter, this current is taken as the tube current in the discharge tube 1). The tube current synthesis/HPF circuit 15 synthesizes the inputted tube currents with regard to all the discharge tubes 1, and extracts a radio-frequency component from the synthesis tube current. The pulse hold circuit 16 holds the radio-frequency component extracted by the tube current synthesis/HPF circuit 15 for a predetermined time (the details will be described later).

The tube current in the discharge tube 1 contains a discharge tube driving frequency component for lighting the discharge tube 1 (hereinafter, referred to as a fundamental component). Moreover, upon occurrence of arc discharge, a radio-frequency pulse component resulting from the arc discharge is superimposed on the tube current in the discharge tube 1. When the tube currents are synthesized with regard to all the discharge tubes 1, the fundamental component of the synthesis tube current is reduced to zero, and only the pulse component resulting from the arc discharge is left on the synthesis tube current. In a high pass filter included in the tube current synthesis/HPF circuit 15, a time constant is set such that the fundamental component of the synthesis tube current is attenuated sufficiently as compared with the pulse component resulting from the arc discharge (specifically, it is preferred that the fundamental component is attenuated to not more than −20 dB).

The control circuit 11 is a commercially available discharge tube driving IC, and includes the logic circuit 20, comparators 21a to 21c, an AND circuit 22, a transistor 23, a comparator 24, and a latch 25. A control circuit-intended power supply voltage Vc is supplied to the control circuit 11. The logic circuit 20 controls the high-voltage transformer drive circuit 12. In the comparators 21a to 21c, one of input terminals is connected to an external input terminal of the control circuit 11, and the other input terminal is applied with a predetermined threshold voltage. In the comparators 21a to 21c, an output is in a HIGH level in a normal state, and changes to a LOW level when an externally inputted signal voltage becomes not less than a threshold value or not more than the threshold value. The AND circuit 22 outputs a logical product of the outputs from the comparators 21a to 21c. The transistor 23 turns to an ON state when the output from the AND circuit 22 is in the HIGH level, and turns to an OFF state when the output from the AND circuit 22 is in the LOW level.

The comparator 24 constitutes a timer circuit 19 in conjunction with the capacitor 17 provided outside the control circuit 11. A timer time of the timer circuit 19 is adjusted by selecting a capacitance value of the capacitor 17. When all the outputs from the comparators 21a to 21c are in the HIGH level, the output from the AND circuit 22 turns to the HIGH level, and the transistor 23 turns to the ON state. Herein, a voltage at a positive-side input terminal of the comparator 24 becomes zero, and the output from the comparator 24 turns to the LOW level. When one of the outputs from the comparators 21a to 21c changes to the LOW level, the output from the AND circuit 22 changes to the LOW level, and the transistor 23 turns to the OFF state. Herein, electric charge is accumulated in the capacitor 17 by a current supplied from a current source, so that the voltage at the positive-side input terminal of the comparator 24 rises. After a lapse of the timer time since the output from the AND circuit 22 has changed to the LOW level, the voltage at the positive-side input terminal of the comparator 24 exceeds the threshold value, and the output from the comparator 24 changes to the HIGH level. As described above, the output from the comparator 24 is in the LOW level in a normal state, and changes to the HIGH level when the state that the output from the AND circuit 22 is in the LOW level is continued by the timer time.

The output from the comparator 24 is inputted to a set terminal of the latch 25. When the output from the latch 25 turns to the HIGH level, the logic circuit 20 stops the operation of the high-voltage transformer drive circuit 12. As described above, the control circuit 11 stops the operation of the high-voltage transformer drive circuit 12 when the state that the externally inputted signal voltage is not less than the threshold value or not more than the threshold value is continued by the timer time. Herein, the operation of the high-voltage transformer 13 is stopped, and the lighting of the discharge tube 1 is stopped.

A positive-side input terminal of the comparator 21a is connected to an output terminal of the pulse hold circuit 16 via an external input terminal of the control circuit 11, and is connected to a control terminal of the timer time switch circuit 18. The timer time switch circuit 18 includes a resistor 28 and a switch 29 which are connected in series. The control circuit-intended power supply voltage Vc is applied to one end of the resistor 28, and one end of the switch 29 is connected to one of electrodes of the capacitor 17. When the output from the pulse hold circuit 16 is in the LOW level, the switch 29 turns to the OFF state. The timer time at this timing is defined as T1. When the output from the pulse hold circuit 16 is in the HIGH level, the switch 29 turns to the ON state, and the control circuit-intended power supply voltage Vc is applied to one of the electrodes of the capacitor 17 via the resistor 28. The timer time at this timing is defined as T2. Herein, the timer time T2 is shorter than the timer time T1.

The control circuit 11 stops the operation of the high-voltage transformer drive circuit 12 when the state that the output from the pulse hold circuit 16 exceeds the threshold value is continued by the timer time T2 and the state that an externally inputted different signal is not less than the threshold value or not more than the threshold value is continued by the timer time T1. As described above, the discharge tube lighting device 10 includes the timer circuit 19 that sets a time elapsed since a signal has changed to an abnormal level until occurrence of an abnormal condition is determined. In the timer circuit 19, a timer time for detecting arc discharge is shorter than a timer time for detecting a different abnormal condition (for example, abnormal current or abnormal voltage).

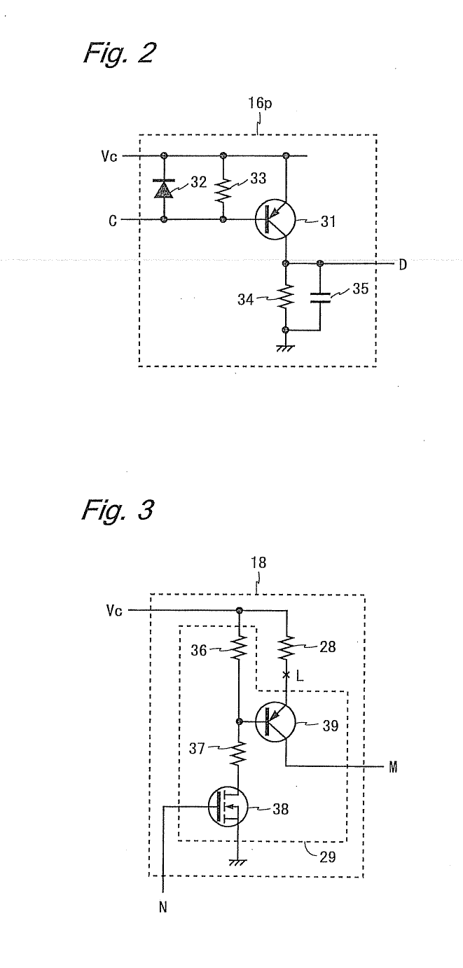

The discharge tube lighting device 10 according to this embodiment includes a pulse hold circuit 16p shown in FIG. 2 as the pulse hold circuit 16. As shown in FIG. 2, the pulse hold circuit 16p includes a bipolar transistor (hereinafter, also referred to as a transistor) 31, a diode 32, resistors 33 and 34, and a capacitor 35. An input terminal of the pulse hold circuit 16p is connected to a base of the transistor 31, and an output terminal of the pulse hold circuit 16p is connected to a collector of the transistor 31. The control circuit-intended power supply voltage Vc is applied to an emitter of the transistor 31. The diode 32 and the resistor 33 are provided in parallel between the base and the emitter of the transistor 31. The resistor 34 and the capacitor 35 are provided in parallel between the collector of the transistor 31 and the ground.

When a current is flown into the input terminal of the pulse hold circuit 16p, a base current is flown into the transistor 31, and a collector current which is h_{FE} times (herein, h_{FE} represents a DC current amplification factor) as large as the base current is flown into the transistor 31. Accordingly, when a current is flown into the input terminal of the pulse hold circuit 16p, a collector voltage at the transistor 31 changes from the LOW level to the HIGH level in a short time. Thereafter, the collector voltage at the transistor 31 gradually changes from the HIGH level and returns to the LOW level after a lapse of a predetermined time. As described above, the pulse hold circuit 16p has such a characteristic that when an input exceeds a predetermined level, an output changes from an initial state in a short time, and then the changed output gradually returns to the initial state.

An attack time (an output rising time) of the pulse hold circuit 16p is adjusted by selecting a characteristic of the transistor 31. A hold time (an output falling time) of the pulse hold circuit 16p is adjusted by selecting a resistance value of the resistor 34 and a capacitance value of the capacitor 35. For example, in a case where burst dimming is performed using a dimming frequency at about 100 Hz to 400 Hz, in other words, in a case where arc discharge occurs intermittently or in a case where small arc discharge is detected, generally, it is preferable that in order to detect arc discharge correctly in a stable manner, the pulse hold circuit 16p holds a pulse component resulting from the arc discharge for several tens of microseconds to several hundreds of microseconds, and the attack time of the pulse hold circuit 16p is set at several nanoseconds to several hundreds of nanoseconds.

FIG. 3 is a circuit diagram of the timer time switch circuit 18. As shown in FIG. 3, resistors 36 and 37, and a MOS-FET 38 are connected in series, and are provided between the ground and a terminal to which the control circuit-intended power supply voltage Vc is applied. The control terminal of the timer time switch circuit 18 is connected to a gate of the MOS-FET 38. The resistor 28 is provided between the terminal to which the control circuit-intended power supply voltage Vc is applied and an emitter of the transistor 39. In the transistor 39, a base is connected to a connection point between the resistors 36 and 37, and a collector is connected to one of the electrodes of the capacitor 17.

When the voltage at the control terminal of the timer time switch circuit 18 is in the LOW level, both the MOS-FET 38 and transistor 39 turn to the OFF state, and the resistor 28 is not connected to one of the electrodes of the capacitor 17. In contrast to this, when the voltage at the control terminal of the timer time switch circuit 18 is in the HIGH level, both the MOS-FET 38 and transistor 39 turn to the ON state, and the capacitor 17 is charged not only by a constant current source in the control circuit 11 but also with the control circuit-intended power supply voltage Vc via the resistor 28. For this reason, the timer time of the timer circuit 19 in the latter case becomes shorter than that in the former case.

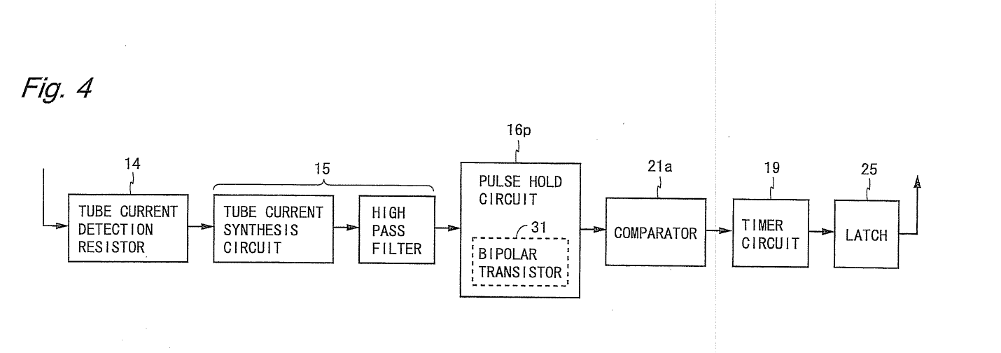

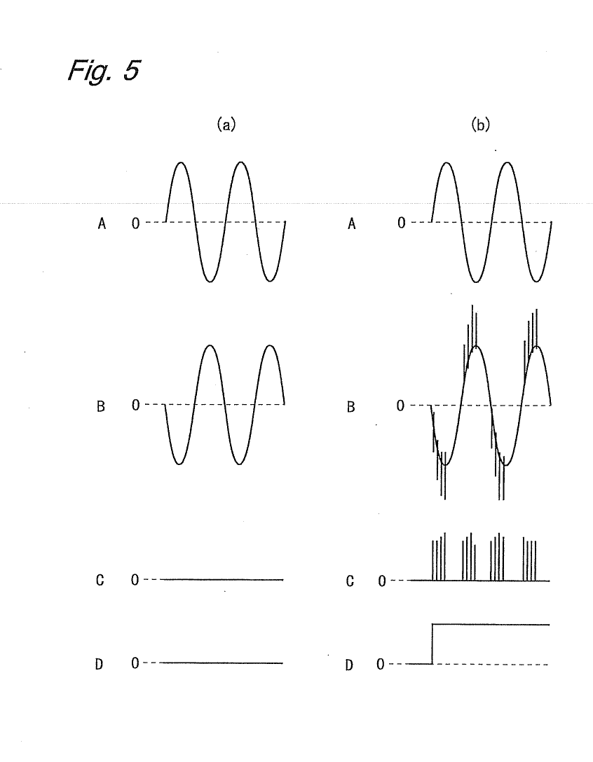

FIG. 4 is a block diagram showing a configuration of an arc discharge detecting section in the discharge tube lighting device 10. As shown in FIG. 4, the arc discharge detecting section includes the tube current detection resistor 14, the tube current synthesis circuit and the high pass filter (the tube current synthesis/HPF circuit 15), the pulse hold circuit 16p including the bipolar transistor 31, the comparator 21a, the timer circuit 19, and the latch 25.

FIG. 5 is a diagram showing changes in a tube current flowing through the point A, a tube current flowing through the point B, a synthesis tube current flowing through a point C, and a voltage at a point ID (the output from the pulse hold circuit 16), in a normal condition and upon occurrence of arc discharge. In the normal condition, as shown in (a) of FIG. 5, the tube current flowing through the point A changes in a sine wave form, and the tube current flowing through the point B changes in a sine wave form which is opposite in phase to the foregoing sine wave form. Accordingly, the synthesis tube current flowing through the point C becomes almost zero, and the voltage at the point D becomes zero (LOW level). Herein, the output from the comparator 21a turns to the HIGH level and the output from the latch 25 turns to the LOW level, so that the logic circuit 20 operates the high-voltage transformer drive circuit 12.

When arc discharge occurs at the second discharge tube 1 from the top in FIG. 1, a radio-frequency pulse component is superimposed on the tube current flowing through the point B as shown in (b) of FIG. 5. For this reason, a pulse component resulting from arc discharge is contained in the synthesis tube current flowing through the point C. When a current is flown into the input terminal of the pulse hold circuit 16, the voltage at the point D changes to the HIGH level in a short time. Herein, the output from the comparator 21a turns to the LOW level and the output from the latch 25 turns to the HIGH level, so that the logic circuit 20 stops the operation of the high-voltage transformer drive circuit 12.

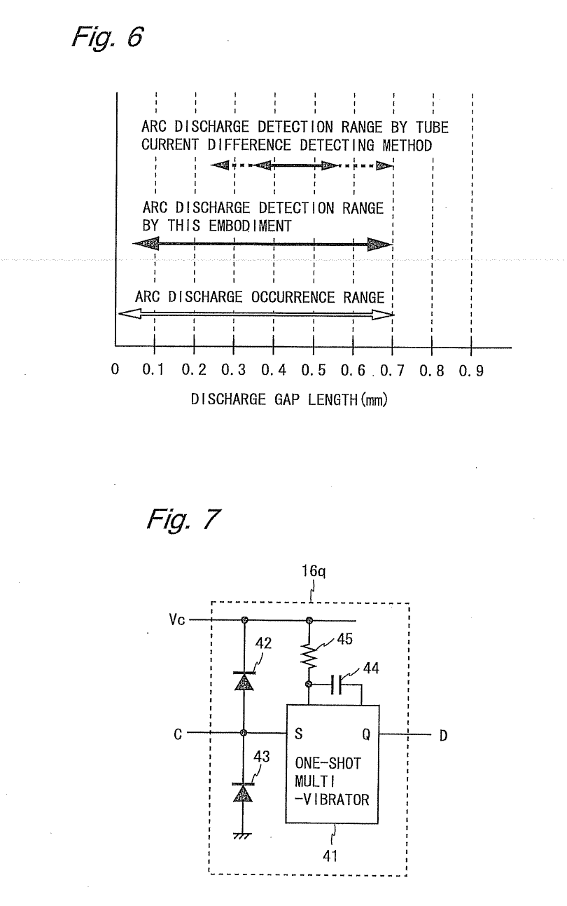

FIG. 6 is a diagram showing an example of arc discharge detection range by the discharge tube lighting device 10. Results shown in FIG. 6 are obtained by a certain experiment. However, an arc discharge occurrence range and the arc discharge detection range vary depending on various conditions such as a shape and a surface state of a conductive section in a gap. Accordingly, the result shown in FIG. 6 is merely an experimental result under a certain condition; therefore, different results may be obtained depending on conditions.

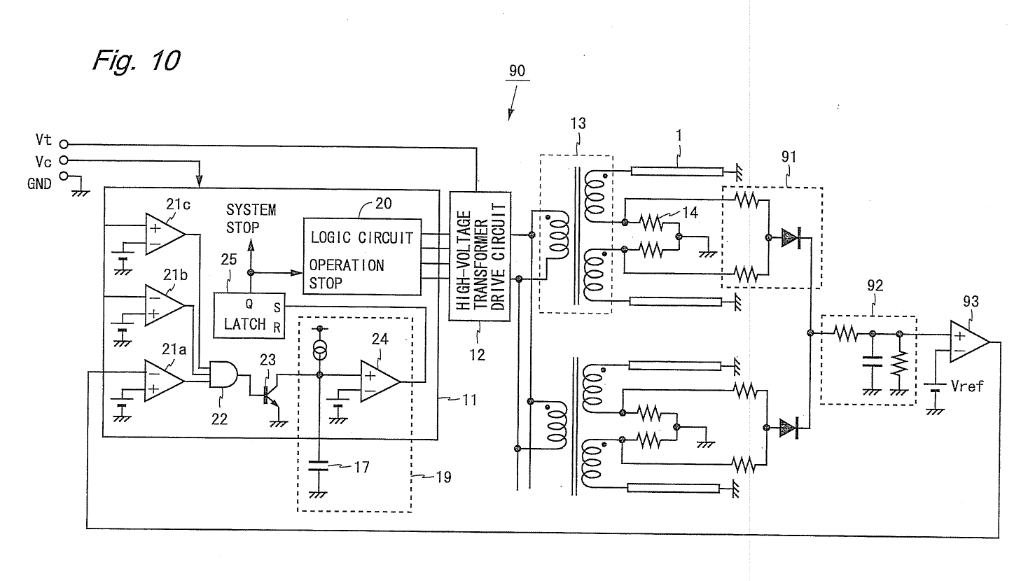

In the example shown in FIG. 6, arc discharge occurs in a case where a discharge gap length is not more than about 0.7 mm. The tube current difference detecting method (FIG. 10) allows detection of arc discharge occurring in a case where the discharge gap length is about 0.35 mm to 0.55 mm (a portion shown with a solid line), and also allows detection of arc discharge occurring in a case where the discharge gap length is about 0.25 mm to 0.35 mm or about 0.55 mm to 0.7 mm (a portion shown with a broken line) although this detection lacks in accuracy. In contrast to this, the discharge tube lighting device 10 according to this embodiment allows detection of arc discharge occurring in a case where the discharge gap length is about 0.05 mm to 0.7 mm. As described above, the discharge tube lighting device 10 according to this embodiment allows detection of arc discharge in a wider range as compared with the tube current difference detecting method.

Hereinafter, description will be given of effects obtained by shortening the timer time of the timer circuit 19 upon detection of arc discharge. Most of commercially available discharge tube driving ICs include only one timer circuit for setting a time elapsed since a signal has changed to an abnormal level until occurrence of an abnormal condition is determined. This timer circuit is principally provided for detecting an under-current in a case where a discharge tube is not lit or an over-voltage generated at a secondary side of a transformer. However, in consideration of a variation in a starting characteristic of a discharge tube, a high voltage to a degree that it is determined as an over-voltage must be applied for not less than one second during a period that the discharge tube is lit at the time of starting to light the discharge tube. In order to prevent a protection circuit from operating to detect the over-voltage at this timing, typically, the timer time of the timer circuit is set at not less than one second. For this reason, in a conventional discharge tube lighting device, a timer time for detecting arc discharge is also set at not less than one second. Arc discharge occurs most frequently at the time of starting to light a discharge tube. However, the conventional discharge tube lighting device detects various abnormal conditions by using one timer circuit, and consequently fails to detect only the arc discharge separately from the other factors. Consequently, the conventional discharge tube lighting device fails to detect arc discharge occurring at this timing and to stop the operation of a circuit in a short time.

The discharge tube lighting device 10 according to this embodiment can detect arc discharge separately from other abnormal conditions, and therefore can switch a timer time quickly upon occurrence of the arc discharge. For example, in the discharge tube lighting device 10, the over-voltage detecting timer time T1 is set at, for example, about 1.5 seconds in consideration of a starting characteristic at a low temperature, and the arc discharge detecting timer time T2 is set at, for example, about 150 ms to 300 ms. As described above, upon occurrence of arc discharge, the operation of the high-voltage transformer drive circuit 12 is stopped in a shorter time as compared with a case where the other abnormal conditions occur. Thus, it is possible to prevent a resin-made member in the vicinity of a place where the arc discharge occurs from being fumed, ignited or carbonized.

As described above, the discharge tube lighting device 10 according to this embodiment includes the drive circuit (the high-voltage transformer drive circuit 12 and the high-voltage transformer 13) for driving the discharge tube 1, the high pass filter (the tube current synthesis/HPF circuit 15) for extracting a pulse component resulting from arc discharge from a tube current in the discharge tube 1, the pulse hold circuit 16 for holding the extracted pulse component for a predetermined time, and the comparator 21a for comparing an output from the pulse hold circuit 16 with a threshold value, and outputting a signal indicating the presence or absence of the arc discharge.

As described above, it is possible to detect arc discharge with high accuracy by extracting a pulse component resulting from the arc discharge from a tube current in the discharge tube 1 and holding the extracted pulse component for a predetermined time. In particular, by holding the extracted pulse component for the predetermined time, it is possible to detect, with high accuracy, small arc discharge which occurs in a case of a narrow discharge gap, has a small average pulse amplitude, and has the small number of pulses having enough amplitude to be taken in by the pulse hold circuit, and arc discharge which occurs intermittently in a case of performing burst dimming, and other cases. Moreover, by extracting only the pulse component resulting from the arc discharge by using the high pass filter, it is possible to detect arc discharge widely from small arc discharge to large arc discharge without being affected by a fluctuation or variation in a fundamental component of a tube current in the discharge tube 1.

Moreover, the discharge tube lighting device 10 further includes the synthesis circuit (the tube current synthesis/HPF circuit 15) for synthesizing tube currents with regard to the plurality of discharge tubes 1, and outputting a signal obtained by the synthesis to the high pass filter. Herein, the drive circuit classifies the plurality of discharge tubes 1 into two groups, and applies voltages, which are opposite in phase, to the discharge tubes 1 in the respective groups. As described above, by synthesizing the tube currents with regard to the plurality of discharge tubes 1 to which the voltages which are opposite in phase are applied in the respective groups, it is possible to reduce a fundamental component of the synthesis signal to a sufficiently small level as compared with a pulse component. Accordingly, it is possible to reduce the cost of the discharge tube lighting device 10 in such a manner that an inexpensive high pass filter having a simple configuration is used for extracting a pulse component resulting from arc discharge.

Moreover, the discharge tube lighting device 10 further includes the timer circuit 19 for setting a time elapsed since a signal has changed to an abnormal level until occurrence of an abnormal condition is determined. In the timer circuit 19, a timer time for detecting arc discharge is shorter than a timer time for detecting a different abnormal condition. As described above, by setting the timer time for detecting arc discharge to be shorter than the timer time for detecting a different abnormal condition, it is possible to detect arc discharge, which may cause a damage of equipment, a fire, and the like, more quickly, to stop the lighting of the discharge tube, and to enhance the safety of the device.

Moreover, the discharge tube lighting device 10 includes, as the pulse hold circuit 16, the pulse hold circuit 16p having a characteristic that when an input exceeds a predetermined level, an output changes from an initial state, and then the changed output gradually returns to the initial state, and including the bipolar transistor 31 that changes the output when the input is changed. By using the pulse hold circuit 16p described above, it is possible to constitute the pulse hold circuit 16 that holds a pulse component extracted by the high pass filter for a predetermined time, at low cost. Moreover, it is possible to improve a reduction characteristic in a case of reducing a fundamental component of a synthesis signal to a sufficiently small level as compared with a pulse component in such a manner that the pulse hold circuit 16p including the bipolar transistor 31 that changes an output when an input is changed is provided at a posterior stage of the synthesis circuit and the high pass filter.

Moreover, an attack time of the pulse hold circuit 16p is set such that an output changes in response to a pulse component resulting from arc discharge. Accordingly, it is possible to reliably change an output from the pulse hold circuit upon occurrence of arc discharge, and to detect the arc discharge with high accuracy. Moreover, a hold time of the pulse hold circuit 16p is set such that the comparator 21a detects arc discharge in a case where a pulse component resulting from the arc discharge is inputted at not more than predetermined time intervals. Accordingly, it is possible to correctly detect arc discharge including small arc discharge which occurs in a case of a narrow discharge gap, has a small average pulse amplitude, and has the small number of pulses having enough amplitude to be taken in by the pulse hold circuit, and arc discharge which occurs intermittently in a case of performing burst dimming, and other cases.

Moreover, a time constant of the high pass filter is set such that a fundamental component of a tube current is sufficiently attenuated as compared with a pulse component resulting from arc discharge. Accordingly, it is possible to correctly extract a pulse component resulting from arc discharge by using the high pass filter, and to detect the arc discharge with high accuracy.

### Second Embodiment

A discharge tube lighting device according to a second embodiment of the present invention has a configuration which is equal to that of the discharge tube lighting device according to the first embodiment (see FIG. 1). The discharge tube lighting device according to this embodiment includes a pulse hold circuit 16q shown in FIG. 7, as the pulse hold circuit 16. Hereinafter, description will be given of a difference between the first and second embodiments.

FIG. 7 is a circuit diagram of the pulse hold circuit 16q in the discharge tube lighting device according to this embodiment. As shown in FIG. 7, the pulse hold circuit 16q includes a one-shot multi-vibrator 41, diodes 42 and 43, a capacitor 44, and a resistor 45. A control circuit-intended power supply voltage Vc is applied to a power supply terminal of the pulse hold circuit 16q. The diode 42 is provided between an input terminal and the power supply terminal of the pulse hold circuit 16q, and the diode 43 is provided between this input terminal and a ground. The capacitor 44 is provided between two control terminals of the one-shot multi-vibrator 41, and the resistor 45 is provided between one of the control terminals and the power supply terminal to which the control circuit-intended power supply voltage Vc is applied. The one-shot multi-vibrator 41 outputs a pulse (one-shot pulse) having a predetermined width when an input exceeds a predetermined level.

A capacitance value of the capacitor 44 and a resistance value of the resistor 45 are set such that the width of the one-shot pulse becomes long sufficiently in consideration of a case of performing burst dimming, and other cases. When a pulse component resulting from arc discharge is inputted to the pulse hold circuit 16q while the one-shot pulse is outputted, the one-shot pulse is extended to have the predetermined width at this timing. Herein, the width of the one-shot pulse becomes widened as compared with a normal state.

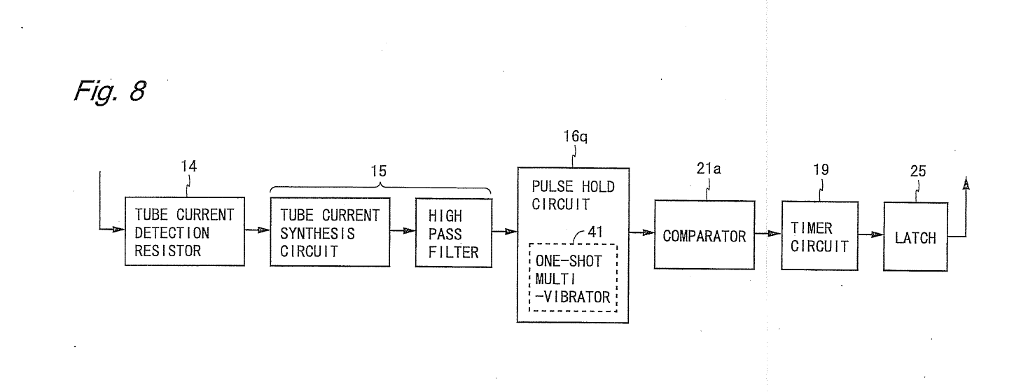

FIG. 8 is a block diagram showing a configuration of an arc discharge detecting section in the discharge tube lighting device according to this embodiment. As shown in FIG. 8, the arc discharge detecting section includes a tube current detection resistor 14, a tube current synthesis circuit and a high pass filter (a tube current synthesis/HPF circuit 15), the pulse hold circuit 16q including the one-shot multi-vibrator 41, a comparator 21a, a timer circuit 19, and a latch 25.

As described above, the discharge tube lighting device according to this embodiment includes, as the pulse hold circuit 16, the pulse hold circuit 16q including the one-shot multi-vibrator 41 that outputs a pulse having a predetermined width when an input exceeds a predetermined level. By using the pulse hold circuit 16q described above, it is possible to constitute the pulse hold circuit 16 that holds a pulse component extracted by the high pass filter for a predetermined time, at low cost. Moreover, it is possible to detect, with high accuracy, arc discharge including small arc discharge which occurs in a case of a narrow discharge gap, has a small average pulse amplitude, and has the small number of pulses having enough amplitude to be taken in by the pulse hold circuit, and arc discharge which occurs intermittently in a case of performing burst dimming, and other cases, and to achieve the stable operation of the discharge tube lighting device.

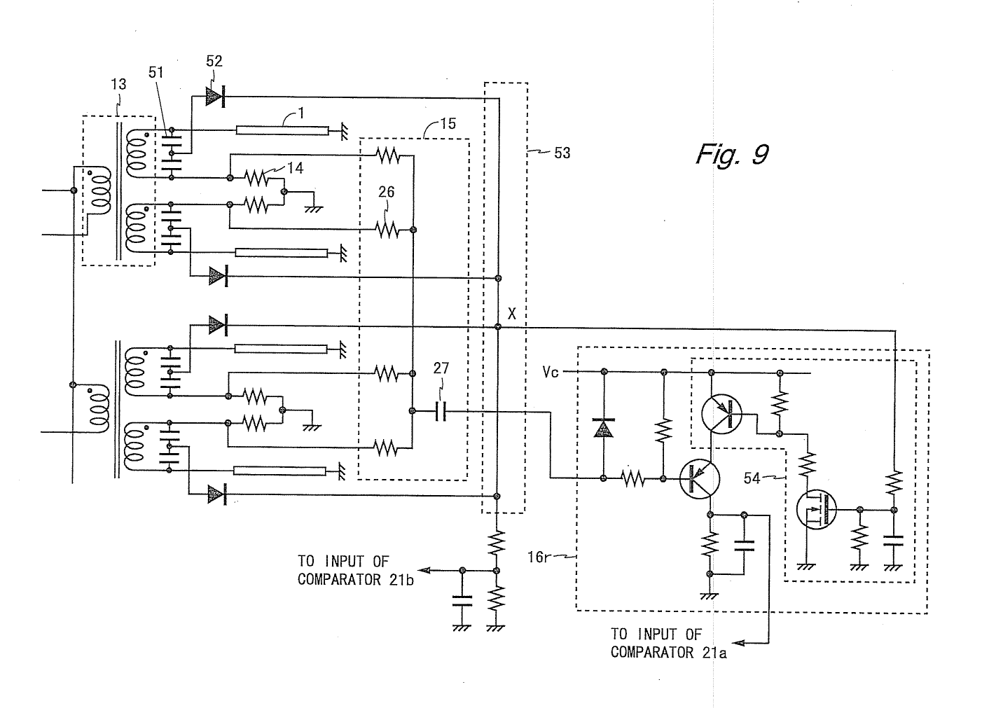

The discharge tube lighting device according to the present invention may employ a modification example shown in FIG. 9. FIG. 9 is a diagram showing a part of the discharge tube lighting device according to the modification example of the embodiment of the present invention. As shown in FIG. 9, in the discharge tube lighting device, two capacitors 51 and one diode 52 are provided for each secondary-side winding of a high-voltage transformer 13 in order to extract a voltage applied to a discharge tube 1. Cathodes of all the diodes 52 are connected to a node X in a tube voltage synthesis circuit 53. At the node X, a voltage obtained by synthesis of tube voltages is obtained. The obtained synthesis tube voltage is fed to one of input terminals of a comparator 21b included in a control circuit 11 via a low pass filter. A pulse hold circuit 16r has such a configuration that a voltage component detection circuit 54 is added to the pulse hold circuit 16p in the first embodiment. The voltage component detection circuit 54 acts so that the pulse hold circuit 16r operates only when the synthesis tube voltage obtained by the tube voltage synthesis circuit 53 exceeds a predetermined level.

In the discharge tube lighting device according to this modification example, the pulse hold circuit 16r operates only when a tube voltage exceeds a predetermined level. As described above, by extracting a pulse component resulting from arc discharge from a tube current, and holding the pulse component extracted by the high pass filter only when a tube voltage exceeds a predetermined level, it is possible to reduce a risk of erroneously detecting a pulse generated in a condition other than arc discharge as a pulse component resulting from arc discharge, and to further enhance arc discharge detecting accuracy.

Moreover, each of the discharge tube lighting devices described above is intended to detect arc discharge, based on a tube current flowing through the discharge tube 1. In place of this, the discharge tube lighting device according to the present invention may detect arc discharge, based on a tube voltage to be applied to the discharge tube. Moreover, the discharge tube lighting device according to the present invention may extract a pulse component resulting from arc discharge from a tube voltage, and hold the pulse component extracted by the high pass filter only when a tube current exceeds a predetermined level. Even in the discharge tube lighting devices according to these modification examples, it is possible to attain effects equal to those of the discharge tube lighting device described above.

Moreover, it is preferable that the number of discharge tubes to be lit by the discharge tube lighting device according to the present invention is an even number; however, this number may be an odd number. In the case of the discharge tube lighting device for lighting odd discharge tubes, a fundamental component contained in a synthesis signal (a sum of fundamental components) does not become zero. For this reason, in the discharge tube lighting device described above, a fundamental component contained in a signal to be inputted to a pulse hold circuit is made small sufficiently with respect to a pulse component resulting from arc discharge in such a manner that a filter characteristic of a high pass filter is made steeper. Thus, it is possible to attain an effect equal to that of the discharge tube lighting device for lighting the even discharge tubes.

### INDUSTRIAL APPLICABILITY

The discharge tube lighting device according to the present invention has such an effect of allowing detection of arc discharge with high accuracy at low cost, and therefore is applicable as various discharge tube lighting devices such as a lighting device for a cold cathode discharge tube included in a backlight of a liquid crystal display device.

### EXPLANATION OF REFERENCE SYMBOLS

1: Discharge tube
10, 50: Discharge tube lighting device
11: Control circuit
12: High-voltage transformer drive circuit
13: High-voltage transformer
14: Tube current detection resistor
15: Tube current synthesis/high pass filter circuit
16p, 16q, 16r: Pulse hold circuit
18: Timer time switch circuit
19: Timer circuit
20: Logic circuit
21, 24: Comparator
25: Latch
31: Bipolar transistor
41: One-shot multi-vibrator
53: Tube voltage synthesis circuit
54: Voltage component detection circuit

1. A discharge tube lighting device having an abnormal discharge detecting function, the discharge tube lighting device comprising:
a drive circuit that drives a discharge tube;
a high pass filter that takes one of a tube current in and a tube voltage at the discharge tube as a processing target signal, and extracts a pulse component resulting from arc discharge from the processing target signal;
a pulse hold circuit that holds the pulse component for a predetermined time; and
a comparator that compares an output from the pulse hold circuit with a threshold value, and outputs a signal indicating the presence or absence of the arc discharge.

2. The discharge tube lighting device according to claim 1, further comprising
a synthesis circuit that synthesizes the processing target signals with regard to a plurality of discharge tubes, and outputs a signal obtained by the synthesis to the high pass filter, wherein
the drive circuit classifies the plurality of discharge tubes into two groups, and applies voltages, which are opposite in phase, to the discharge tubes in the respective groups.

3. The discharge tube lighting device according to claim 1, further comprising
a timer circuit that sets a time elapsed since a signal has changed to an abnormal level until occurrence of an abnormal condition is determined, wherein
in the timer circuit, a timer time for detecting arc discharge is shorter than a timer time for detecting a different abnormal condition.

4. The discharge tube lighting device according to claim 1, wherein
the pulse hold circuit has a characteristic that when an input exceeds a predetermined level, an output changes from an initial state, and then the changed output gradually returns to the initial state.

5. The discharge tube lighting device according to claim 4, wherein
an attack time of the pulse hold circuit is set such that an output changes in response to the pulse component.

6. The discharge tube lighting device according to claim 4, wherein
a hold time of the pulse hold circuit is set such that the comparator detects the arc discharge when the pulse component is inputted at not more than predetermined time intervals.

7. The discharge tube lighting device according to claim 2, wherein
the pulse hold circuit has a characteristic that when an input exceeds a predetermined level, an output changes from an initial state, and then the changed output gradually returns to the initial state, and includes a bipolar transistor that changes the output when the input is changed.

8. The discharge tube lighting device according to claim 1, wherein
a time constant of the high pass filter is set such that a discharge tube driving frequency component of the processing target signal is attenuated sufficiently as compared with the pulse component.

9. The discharge tube lighting device according to claim 1, wherein
the pulse hold circuit includes a one-shot multi-vibrator that outputs a pulse having a predetermined width when an input exceeds a predetermined level.

10. The discharge tube lighting device according to claim 1, wherein
the pulse hold circuit operates only when one of the tube current and the tube voltage, which is not taken as the processing target signal, exceeds a predetermined level.

11. An abnormal discharge detecting method in a discharge tube lighting device, comprising:
a step of taking one of a tube current in and a tube voltage at a discharge tube as a processing target signal, and performing high pass filter processing to extract a pulse component resulting from arc discharge from the processing target signal;
a step of holding the pulse component for a predetermined time by using a pulse hold circuit; and
a step of comparing an output from the pulse hold circuit with a threshold value, and determining the presence or absence of the arc discharge.

12. The abnormal discharge detecting method according to claim 11, further comprising:
a step of classifying a plurality of discharge tubes into two groups, and applying voltages, which are opposite in phase, to the discharge tubes in the respective groups; and
a step of synthesizing the processing target signals with regard to the plurality of discharge tubes, and obtaining a signal to be subjected to the high pass filter processing.

13. The abnormal discharge detecting method according to claim 11, further comprising
a step of setting a time elapsed since a signal has changed to an abnormal level until occurrence of an abnormal condition is determined, by using a timer circuit, wherein
in the timer circuit, a timer time for detecting arc discharge is shorter than a timer time for detecting a different abnormal condition.

14. The abnormal discharge detecting method according to claim 11, wherein
the pulse hold circuit has a characteristic that when an input exceeds a predetermined level, an output changes from an initial state, and then the changed output gradually returns to the initial state.

15. The abnormal discharge detecting method according to claim 11, wherein
the pulse hold circuit includes a one-shot multi-vibrator that outputs a pulse having a predetermined width when an input exceeds a predetermined level.
